(19) United States
(12) Patent Application Publication
(10) Pub. No.: US 2008/0152933 A1
(43) Pub. Date: Jun. 26, 2008

(54) CURABLE RESIN MATERIAL-FINE PARTICLE COMPOSITE MATERIAL AND METHOD OF PRODUCING THE SAME, OPTICAL MATERIAL, AND LIGHT EMITTING DEVICE

(75) Inventors: Mikihisa Mizuno, Miyagi (JP); Shung-kil Lee, Miyagi (JP); Yuichi Sasaki, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/956,237

(22) Filed: Dec. 13, 2007

(30) Foreign Application Priority Data
Dec. 21, 2006 (JP) 2006-343677

(51) Int. Cl. B32B 27/06; C08K 5/3417; C08K 5/37; C08K 5/42

(52) U.S. Cl. 428/480; 524/133; 524/157; 524/167; 524/236

(57) ABSTRACT

A curable resin material-fine particle composite material, an optical material, and a light emitting device are disclosed. The composite material includes a resin material of an uncured or semicured resin and fine particles of an inorganic material dispersed in the resin material. The surface of the fine particles is treated by at least first and second surface treatment agents composed of molecules represented by the formulas (1) and (2), respectively:

first surface treatment agent: R¹—X¹ (1)

second surface treatment agent: R²—X² (2)

wherein R¹ represents a long-chain aliphatic or alicyclic hydrocarbon group, R² represents a hydrocarbon group having a structure showing affinity with at least a portion of monomers composing the resin material, and X¹ and X² independently represent a carboxyl group —COOH, hydrohydroxyphosphoryl group —PH(O)(OH), phosphono group —PO(OH)₂, sulfino group —SO(OH), sulfo group —SO₂(OH), thiol group —SH, amino group —NH₂, or vinyl group —CH═CH.

### CROSS REFERENCES TO RELATED APPLICATIONS

The present application claims priority to Japanese patent Application No. 2006-343677 filed in the Japanese Patent Office on Dec. 21, 2006, the entire contents of which is incorporated herein by reference.

### BACKGROUND

The present application relates to a curable resin material-fine particle composite material used for composing a resin-fine particle composite modified in properties of resin by adding inorganic fine particles, a method of producing the same, an optical material composed of the resin-fine particle composite obtained by curing the curable resin-fine particle composite material, and a light emitting device using the optical material.

In recent years, there has been an increasing trend of using optical material (simply referred to as organic optical resin, hereinafter) composed of an organic polymer resin, as a material for composing general optical components such as lens, light-transmissive film and so forth, or for composing precision optical components applied to optoelectronics. This is supposedly because the organic optical resin is lightweight, lower in price, less likely to be fractured, excellent in workability and mass-productivity, as compared with inorganic optical materials.

For example, the organic optical resin is used as a sealing member or the like of light emitting devices provided with light emitting elements such as light emitting diode (LED), laser diode (LD) and so forth. By virtue of their high luminance despite their small sizes, the light emitting devices are adopted to various applications including brake lamp of automobiles, traffic signal lamp, outdoor large display and so forth. Recent applications also include backlight sources for liquid crystal displays of mobile phones or large-sized liquid crystal television sets or the like.

FIG. 5 is a sectional view showing a general structure of the light emitting device. As shown in FIG. 5, a light emitting device 100, has a light emitting element 13 disposed in a recess 12 of a reflective cup 11, and has a sealing member 114 disposed in contact with the light emitting element 13 so as to fill the recess 12. Light emitted from the light emitting element 13 goes across the interfacial plane with the sealing member 114, advances through the sealing member 114, and is extracted to the outside directly, or after being reflected on the wall surface of the reflective cup 11.

The sealing member 114 is disposed on or over the light emitting element 13, as being appropriately adjusted in the geometry or thickness thereof depending on purposes of the light emitting device 100. Epoxy resin such as bisphenol A glycidyl ether-type epoxy resin, which is a sort of organic optical resins, has been used as the material of the sealing member. This resin is, however, poor in heat resistance and light resistance, in particular light resistance against ultraviolet (UV) radiation and blue light, and may cause discoloration induced by heat and light emitted from LED when used under irradiation with high luminance LED, UV-emitting LED or the like, causing degradation in the luminance in a time-dependent manner. High-transparency-type epoxy resin has been developed as one solution for this problem, but is still on the way to satisfactory levels of heat resistance and light resistance.

For this reason, there is an increasing trend of using silicone resin which is superior to epoxy resin in terms of heat resistance and light resistance, as a material for composing the sealing member 114 of the high luminance LED. However, such an epoxy resin is inferior in light extraction efficiency since the silicone resin has a refractive index of 1.41 to 1.51, which is smaller than that of epoxy resin.

As a consequence, the main stream of the high-luminance LED is such as adopting a sapphire substrate as the chip substrate thereof, so as to allow extraction of light from the sapphire substrate side. In view of ensuring efficient extraction of light emitted from the high-luminance LED to the sealing member 114 side, while avoiding total reflection of light on the interfacial plane between the sapphire substrate and the sealing member 114, the sealing member 114 preferably has the refractive index of as close as 1.76, which is refractive index of the sapphire substrate. However, the refractive indices of silicone resins are only as large as 1.41 for general dimethyl silicone resin, and even as large as 1.51 for silicone resins of diphenyl dimethyl-base or phenyl methyl-base, the refractive indices of which being raised by introducing phenyl groups, which are smaller than those of epoxy resins ranging from 1.53 to 1.57. Accordingly, the use the silicone resin as a material for composing the sealing member 114 of high-luminance LED inevitably lowers the light extraction efficiency, as compared with the case where the epoxy resins are used.

As described in the above, it has been understood that the organic optical resins generally have small refractive indices, and that it is difficult to obtain those having refractive indices exceeding 1.7. On the other hand, nano-particles having particle sizes of 1 μm or smaller have recently been attracting public attention. The particle size smaller than wave length of light by a factor of ¼ is almost not causative of scattering of the light. Some of the nano-particles, composed of metal oxides and the like, are known to have large refractive indices. Current research and development are therefore made on producing a composite having high-refractive-index inorganic nano-particles dispersed in the organic optical resins, aiming at realizing materials light in weight, low in price, less likely to fracture, excellent in workability and mass-productivity, similarly to the organic optical resins, and also large in refractive index.

For example, Japanese unexamined Patent Application Publication (KOKAI) No. 2004-15063 (pages 8-10, FIGS. 2 and 3, Patent Document 1) proposes a light emitting device configured to extract light from a light emitting element such as light emitting diode from the substrate side through the above-described composite. The organic optical resin herein is exemplified by epoxy resin, silicone resin, acryl resin, polycarbonate resin and so forth, the high-refractive-index inorganic material is exemplified by calcium oxide, cerium oxide, hafnium oxide, titanium oxide, zinc oxide, zirconium oxide and so forth, with description that addition of the high-refractive-index inorganic nano-particle may improve the refractive index of the composite to as large as 1.5 to 1.8 or around.

The Patent Document 1, however, gives no description on a method of producing the composite. A general method generally adopted when the inorganic nano-particles are uniformly dispersed into the organic optical resin is such as dispersing the inorganic nano-particles into an appropriate solvent to thereby obtain a dispersion liquid, uniformly mixing therewith a liquid-form, UV-curing organic optical resin monomer, and allowing the monomer to polymerize under UV irradiation to thereby synthesize a composite of the organic optical resin and inorganic nano-particles. The inorganic nano-particle in this process are generally poor in affinity to organic materials, but show strong force of agglomeration exerted thereamong, and may be likely to form a secondary agglomeration to thereby impair transparency of the composite. In order to avoid such secondary agglomeration, it is apparent that some sort of surface treatment will be necessary on the surface of the inorganic nano-particles.

In conjunction with this sort of surface treatment of the inorganic nano-particles, Japanese Patent Application Publication (KOKAI) No. 2003-73558 (pages 2-4, Patent Document 2) for example proposes a composite containing, as dispersed in a polymer having an electron-donating ability, ultrafine metal oxide fine particles having a particle size of 1 to 100 nm, modified on the surface thereof with acidic groups, or both of acidic groups and basic groups. The polymer herein is exemplified by polyether, polycarbonate, polyester, polyamide, polyethylene oxide, polymethyl methacrylate, copolymer of bisphenol-A and epichlorohydrin and so forth, surface treatment agents having the acidic group is exemplified by saturated or unsaturated aliphatic carboxylic acid having 1 to 20 carbon atoms, and surface treatment agents having the basic group is exemplified by saturated or unsaturated aliphatic amine having 1 to 20 carbon atoms.

Japanese Unexamined Patent Application Publication (KOKAI) No. 2006-273709 (pages 4 to 9, Table 1: Patent Document 3) proposes nano-particles composed of a metal oxide such as titanium oxide, zirconium oxide or the like, and covered with a surface treatment agent having a predetermined chemical structure, having a refractive index of 1.8 or above, and being excellent in compatibility with a resin monomer. It is described that the surface treatment agent has a portion (A) showing adsorptivity or reactivity to the nano-particles, a portion (B) imparting compatibility with the acryl resin monomer to the nano-particles, and a portion (C) showing a high refractive index, and may disperse the nano-particles into a wide range of acryl resins while keeping the high refractive index.

The portion (A) is any one of (I) a group capable of forming an ionic bonding, (II) a group capable of forming a covalent bond through reaction with the nano-particles, and (III) a group capable of forming a hydrogen bonding or coordinate bonding, wherein it is exemplified that (I) is any one of acidic group and its salt, and basic group and its salt, (II) is any one of —Si(OR¹)₃, —Ti(OR²)₃, isocyanate group, epoxy group, and episulfide group, and (III) is any one of hydroxyl group, thiol group, and phosphine oxide. It is also exemplified that the portion (B) is any one of (meth)acryl group, polyalkylene glycol group (polyethylene glycol group, polypropylene glycol group, etc.), and aromatic group, that the portion (C) is composed of at least one sulfur atom and at least one aromatic ring, and that the surface treatment agent per se has a refractive index of 1.52 or larger.

A method of producing a composite has been proposed in the literature (C. Lu, Y. Cheng, Y. Liu, F. Liu, B. Yang, Adv. Mater., (2006), 18, 1188, hereinafter referred to as Non-Patent Document 1). The literature discloses the method in which zinc sulfide (ZnS) nano-particles are covered with mercaptoethanol, dispersed into a mixed solvent of dimethyl acrylamide and styrene and divinylbenzene, and then dimethylacryl amide and styrene and divinylbenzene are polymerized by γ-ray irradiation.

As described previously, Patent Document 1 gives no description on surface treatment of the inorganic nano-particles. In each of surface treatment agents having an acidic group (saturated or unsaturated aliphatic carboxylic acid having 1 to 20 carbon atoms), and a basic group (saturated or unsaturated aliphatic amine having 1 to 20 carbon atoms) described in Patent Document 2, amount of addition of inorganic nano-particles possibly dispersed into the composite, degree of improvement in the refractive index in the composite, and species of adoptable organic resin material are limited in narrow ranges.

An effort of imparting all of the portion (A) showing adsorptive property or reactivity to the nano-particles, the portion (B) imparting compatibility with the acryl resin monomer, and the portion (C) showing a high refractive index to a single species of molecule, as shown by the surface treatment agent described in Patent Document 3, makes molecule of the surface treatment agent very specific. In fact, the surface treatment agents described in Patent Document 3, excluding phenyl thioacetic acid, are not readily available. Any modification in properties of the resin material raises a need of modifying the portion (B) in concordance therewith, and a need of synthesizing a separate surface treatment agent at every time.

A recent proposal has been made on use of a fluorene group-containing acryl resin raised in the refractive index through introduction of fluorene group, as a sealing member for high luminance LED or the like. The resin has a refractive index equivalent or superior to that of epoxy resin, and also excellent in heat resistance and light resistance. It is now expected that the fluorene group-containing acryl resin-inorganic nano-particle composed of the fluorene group-containing acryl resin and the inorganic nano-particles having a high refractive index dispersed therein will have a still larger refractive index, and the LED sealed by the composite will further be improved in the efficiency of light extraction. However, the surface treatment agent having the configuration shown in Patent Document 3, and optimized for the above-described fluorene group-containing acryl resin has not been synthesized yet.

When mercaptoethanol shown in Non-Patent Document 1 is used as the surface treatment agent, problems will arise in that (1) species of dispersible acryl resins are limitative, and that (2) the upper limit resides with respect to the size of dispersible and stabilizable particles, due to shortness of the molecular chain. It is supposed that particles having a particle size of 5 nm or larger could not be dispersed.

### SUMMARY

The present application addresses the above-identified issues associated with such circumstances to provide a curable resin-fine particle composite material adaptable to changes in the organic resin material, a method of fabricating the same, an optical material composed of a resin-fine particle composite obtained by curing such curable resin-fine particle composite material, and a light emitting device using such optical material.

In accordance with a first aspect, there is provided a curable resin-fine particle composite material including a resin material of an uncured or semicured resin and fine particles composed of an inorganic material dispersed in the resin material. The surface of the fine particles is treated by at least a first surface treatment agent and a second surface treatment agent, and the first surface treatment agent and the second surface treatment agent are composed of molecules represented by the general formulas (1) and (2), respectively:

first surface treatment agent: R¹—X¹ (1)

second surface treatment agent: R²—X² (2)

(wherein R¹ represents a long-chain aliphatic or alicyclic hydrocarbon group preventing agglomeration of the fine particles, a part of hydrogen atom(s) of the hydrocarbon group may be substituted by substituent(s), R² represents a hydrocarbon group having a structure showing affinity with at least a portion of monomers composing the resin material, and having a reactive portion polymerizable with the resin material in the process of curing thereof, or a derivative group produced by substituting a part of hydrogen atom(s) with substituent(s), and X¹ and X² independently represent a carboxyl group —COOH, hydrohydroxyphosphoryl group —PH(O)(OH), phosphono group —PO(OH)₂, sulfino group —SO(OH), sulfo group —SO₂(OH), thiol group —SH, amino group —NH₂, or vinyl group —CH═CH₂).

In accordance with a second aspect, there is provided also a method of producing the above-described curable resin-fine particle composite material, which includes:

dispersing, in a solvent containing at least the first surface treatment agent and the second surface treatment agent, the fine particles so as to resolve secondary agglomeration thereof, and so as to be treated on the surface thereof with the first surface treatment agent and the second surface treatment agent, and

then mixing the treated fine particles with the uncured or semicured resin material.

In accordance with a third aspect, there is provided also an optical material composed of a resin-fine particle composite obtained by curing such curable resin-fine particle composite material, and still also a light emitting device configured so that light emitted from a light emitting element is extracted through such optical material.

A characteristic feature of the curable resin-fine particle composite material is to use, as the surface treatment agent, two or more species of surface treatment agents having different characteristics, that is, to use at least the first surface treatment agent and the second surface treatment agent.

The first surface treatment agent R¹—X¹ is adsorbed onto the surface of the fine particles by contribution of group X¹, whereas the hydrocarbon group R¹, which is a long-chain aliphatic or alicyclic hydrocarbon group, covers the surface of the fine particles in a thick manner. The agent, therefore, functions as a steric hindrance preventing agglomeration of the individual fine particles with each other to produce the secondary agglomeration, and thereby contributes to dispersion and stabilization of the fine particles. R¹ may be any of straight-chain, branched and cyclic, may be either of saturated and unsaturated, and may have various substituents. It is also allowable to use two or more species of the first surface treatment agent if necessary.

On the other hand, the second surface treatment agent R²—X² is a smaller molecule as compared with the first surface treatment agent, wherein R² has a structure showing affinity with at least a portion of monomers composing the resin material. As a consequence, once adsorbed onto the surface of the fine particles by contribution of group X², the agent imparts the fine particles with affinity to the uncured or semicured resin material, and thereby contributes to dispersion and stabilization of the fine particles. R² has a reactive site polymerizable with the resin material in the process of curing the resin material, so that when the uncured or semicured resin material is cured by polymerization, a part of them may be polymerized with the resin material and integrated therewith, and can thereby hold the fine particles in the cured resin-fine particle composite. It is also allowable to use two or more species of the second surface treatment agent, if necessary.

As has been described in the above, in embodiments, functions which should be owned by the surface treatment agent are shared at least by the first surface treatment agent and the second surface treatment agent, and are realized by any combination of a plurality of surface treatment agents. Therefore, it becomes possible to use general and readily-available materials for the first surface treatment agent and the second surface treatment agent, so that it is no more necessary to newly synthesize a special material such as the configuration shown in Patent Document 3. The first surface treatment agent and the second surface treatment agent may be used based on appropriate selection depending on physical properties, such as transparency, light resistance, heat resistance and so forth, required for the curable resin-fine particle composite material, wherein appropriate selection in particular of the second surface treatment agent may make the composite flexibly adapted to changes in characteristics of the uncured or semicured resin material. Independent use of the first surface treatment agent and the second surface treatment agent results in a limited performance of allowing the fine particles to disperse into the uncured or semicured resin material.

According to an embodiment of the method of producing a curable resin-fine particle composite material is dispersing, in a solvent containing at least the first surface treatment agent and the second surface treatment agent, the fine particles to resolve secondary agglomeration thereof, and to be treated on the surface thereof with the first surface treatment agent and the second surface treatment agent; and then mixing the treated fine particles with the uncured or semicured resin material, so that the secondary agglomeration of the fine particles may be resolved, and thereby the curable resin-fine particle composite material may be produced in a reliable manner.

The optical material of an embodiment is composed of a resin-fine particle composite of the resin obtained by curing the uncured or semicured resin material and the fine particles. Because the surface of the fine particles is treated by at least the first surface treatment agent and the second surface treatment agent, the resin-fine particle composite in which the fine particles is uniformly dispersed in the resin may be obtained without causing the secondary agglomeration. In particular, if the fine particles having a small particle size and being composed of a high-refractive-index inorganic material, are used, the optical material, composed of a resin-fine particle composite which is transparent, light weight, inexpensive, less likely to fracture, and excellent in processability and mass productivity similarly to the material composed of the resin only, may be obtained. The optical material may also have a larger refractive index than the material composed of the resin only. In this specification, the term “being transparent” means that transmissivity of light, measured conforming to the method of measuring transmissivity of light described later in Examples, is 80% or above over a wavelength range of visible light from 380 nm to 750 nm.

According to the light emitting device of an embodiment, the light emitted from a light emitting element is extracted through the optical material of the present application. By virtue of this configuration, the efficiency of light extraction may be improved by using, as the optical material, the resin-fine particle composite having a refractive index larger than that of the material composed of the resin only.

Additional features and advantages are described herein, and will be apparent from, the following Detailed Description and the figures.

### BRIEF DESCRIPTION OF THE FIGURES

FIG. 1 is a sectional view schematically showing a structure of a light emitting device according to Example 1;

FIG. 2 is a sectional view schematically showing a structure of a light emitting device according to Example 2;

FIG. 3 is a sectional view schematically showing a structure of a light emitting device according to Example 3;

FIG. 4 is a sectional view schematically showing a structure of a light emitting device according to Example 4; and

FIG. 5 is a sectional view schematically showing a structure of a conventional light emitting device.

### DETAILED DESCRIPTION

In the curable resin-fine particle composite material of embodiments and a method of producing the same, R¹ is preferably a substituted or non-substituted hydrocarbon group having 5 to 18 carbon atoms. More specifically, when X¹ represents a carboxyl group, the first surface treatment agent may typically be hexanoic acid, heptanoic acid, octanoic acid, nonanoic acid, decanoic acid, dodecanoic acid, tetradecanoic acid, pentadecanoic acid, hexadecanoic acid, heptadecanoic acid, octadecanoic acid, oleic acid, linoleic acid, cyclohexane carboxylic acid, 1-adamantanecarboxylic acid and so forth.

R² may preferably be a substituted or non-substituted hydrocarbon group having 2 to 4 carbon atoms, and having a carbon-carbon double bond at the terminal thereof. If the uncured or semicured resin material used herein is a resin material curable by addition polymerization, a part of the molecule of which may be integrated with the resin material by copolymerization. More specifically, if X² is a carboxyl group, the second surface treatment agent may be acrylic acid, methacrylic acid, vinylacetic acid, 4-pentenoic acid and so forth.

R² may preferably have a structure similar to that of the principal chain portion and/or side chain portion of the monomer composing the resin material. For an exemplary case where the monomer is an acrylate, the second surface treatment agent may preferably be acrylic acid (or methacrylic acid) having the principal portion same as that of the acrylate, with the ester bond portion substituted by a carboxyl group. This means that a surface treatment agent having the strongest affinity to the monomer composing the uncured or semicured resin material is selected as the second surface treatment agent, and thereby the fine particles may most effectively be dispersed into the uncured or semicured resin material.

The surface of the fine particles are preferably treated with the first surface treatment agent, the second surface treatment agent, and third surface treatment agent expressed by the formula (3) below:

third surface treatment agent: R³—X³ (3)

(wherein R³ represents an aromatic hydrocarbon group or aromatic heterocyclic group, a part of hydrogen atom(s) may be substituted by substituent(s), and X³ represents a carboxyl group —COOH, hydrohydroxyphosphoryl group —PH(O)(OH), phosphono group —PO(OH)₂, sulfino group —SO(OH), sulfo group —SO₂(OH), thiol group —SH, amino group —NH₂, or vinyl group —CH═CH₂).

In general formula (3), R³ represents an aromatic hydrocarbon group or aromatic heterocyclic group, and may have various substituents. The aromatic hydrocarbon group is a monocyclic or polycyclic aromatic hydrocarbon group such as phenyl group, biphenyl group, diphenyl methyl group, terphenyl group, triphenyl methyl group, naphthalene group, fluorene group, anthracene group and pyrene group, and the aromatic heterocyclic group is a monocyclic or polycyclic aromatic heterocyclic group such as pyrrole group, thiophene group, thiazole group, indole group, benzothiophene group, benzothiazole group, carbazole group and dibenzothiophene group.

More specifically, when X³ is a carboxyl group, the third surface treatment agent may be benzoic acid, 3-acetylbenzoic acid, 4-acetylbenzoic acid, 2-methylbenzoic acid, 3-methylbenzoic acid, 4-methylbenzoic acid, 4-butylbenzoic acid, 4-tert-butylbenzoic acid, 3,5-di-tert-butylbenzoic acid, 2-methoxybenzoic acid, 3-methoxybenzoic acid, 4-methoxybenzoic acid, 2-ethoxybenzoic acid, 3-ethoxybenzoic acid, 4-ethoxybenzoic acid, 4-n-butoxybenzoic acid, 2-phenoxybenzoic acid, 3-phenoxybenzoic acid, 4-phenoxybenzoic acid, 3-vinylbenzoic acid, 4-vinylbenzoic acid, phenylacetic acid, diphenylacetic acid, (±)-2-phenyl propanoic acid, 3-phenyl propanoic acid, 2,2-diphenyl propanoic acid, 3,3-diphenyl propanoic acid, 4-biphenylacetic acid, triphenylacetic acid, phenoxyacetic acid, biphenyl-2-carboxylic acid, biphenyl-4-carboxylic acid, 1-naphthoic acid, 2-naphthoic acid, 1-naphthylacetic acid, 2-naphthylacetic acid, (2-naphthylthio)acetic acid, fluorene-1-carboxylic acid, fluorene-4-carboxylic acid, fluorene-9-carboxylic acid, 9-anthracenecarboxylic acid, 1-pyrenecarboxylic acid, pyrrole-2-carboxylic acid, 2-thiophenecarboxylic acid, 3-thiophenecarboxylic acid, 3-(2-tienyl)acrylic acid, 4-thiazolecarboxylic acid, indole-2-carboxylic acid, indole-3-carboxylic acid, indole-4-carboxylic acid, indole-5-carboxylic acid, indole-6-carboxylic acid, benzo[b]thiophene-2-carboxylic acid, benzothiazole-6-carboxylic acid, 4-dibenzothiophenecarboxylic acid and so forth.

The third surface treatment agent may be used based on appropriate selection depending on refractive index, transparency, light resistance and heat resistance required for the curable resin-fine particle composite material. For example, the carboxylic acids have retractive indices of as large as 1.56 to 1.78 (calculated value), so that it is preferable to use one or more species of them to disperse the fine particles, in order to increase the refractive index of the curable resin-fine particle composite material. The dispersing performance of the fine particles into the uncured or semicured resin material is insufficient, if the third surface treatment agent is used alone, or if the second surface treatment agent is not used and the first surface treatment agent and the third surface treatment agent are used.

The curable resin-fine particle composite material may be transparent. By this configuration, the resin-fine particle composite obtained as cured may be used as an optical material.

As the transparent curable resin-fine particle composite material, the uncured or semicured resin material may contain an acryl resin material. The acryl resin is one of representative organic optical resin. The acryl resin is also advantageous in that various products may readily be obtained by modifying an atomic group to be bound through an ester bond with acrylic acid or methacrylic acid.

The curable resin-fine particle composite material composed of acryl resin material preferably may have a refractive index of 1.58 or larger. The curable resin-fine particle composite material in this case has a refractive index larger than those of existent epoxy resins and fluorene group-containing acryl resins, and consequently has larger value as an optical resin material. The curable resin-fine particle composite material may have a viscosity at 80° C. of 1×10⁵ mPa·s or smaller (measured value obtained by using an type-E viscometer, the same will apply hereinafter). The curable resin-fine particle composite material thus configured may be suitable for provision by thin film coating, printing, injection or the like.

For example, fluorene-group-containing acrylate and/or methacrylate may preferably be contained as the monomer for composing the acryl resin material. As has been described previously, the fluorene group-containing acryl resin having fluorene groups introduced therein is raised in the refractive index to a level equivalent to or larger than that of epoxy resin, and also excellent in the heat resistance and light resistance. The fluorene group-containing acryl resin-fine particle composite having the high-refractive-index inorganic fine particles dispersed into the fluorene group-containing acryl resin will have a still larger refractive index, so that an LED sealed with this composite is expected to be improved in the efficiency of light extraction to a large degree.

More specifically, the monomer composing the acryl resin material preferably contains a fluorene-group-containing acrylate and/or methacrylate expressed by the general formula (4), and a monofunctional acrylate and/or methacrylate expressed by the general formula (5) and/or general formula (6), as the monomers composing the acryl resin material. It is to be understood herein that “monofunctional” in the monofunctional acrylate or methacrylate means “having a single acryloyloxy group CH₂═CHCOO— or methacryloyloxy group CH₂═C(CH₃)COO—”.

Fluorene-group-containing acrylate or methacrylate:

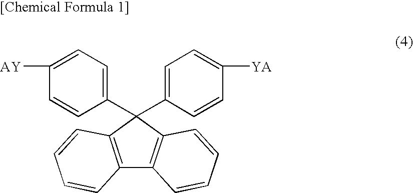

(wherein A represents an acryloyloxy group or methacryloyloxy group, and Y represents a —(CH₂CH₂O)ₙ— or (CH₂CH₂O)ₙ—CH₂CH(OH)CH₂O—, n=1 to 5).

monofunctional acrylate or methacrylate: B-Z-T (5)

B-Z-T(R^{X})ₘ (6)

(wherein B represents an acryloyloxy group or methacryloyloxy group, Z represents —(CH₂CH₂O)ₙ— or —(CH₂CH₂CH₂O)ₙ—, n=1 to 5, or, —(CH₂CH₂O)ₙ₁—(CH₂CH₂CH₂O)ₙ₂—, n1+n2=2 to 5, T represents an aromatic hydrocarbon group, a part of hydrogen atom(s) may be substituted by substituent(s) as expressed by the general formula (6), R^{X} represents a methyl group, bromine atom or iodine atom, and m=1 to 6).

The fluorene-group-containing acrylate or methacrylate has a refractive index of 1.57 to 1.62 before being cured, and a refractive index of 1.58 to 1.65 after being cured, which are equivalent to or larger than that of epoxy resin. The compound is also excellent in the heat resistance and light resistance. In general formula (4), n of larger than 5 will excessively lower the refractive index, and may be not preferable.

More specifically, the fluorene-group-containing acrylate may be 9,9′-bis(4-(2-acryloyloxyethoxy)phenyl)fluorene, 9,9′-bis(4-(2-(3-acryloyloxy-2-hydroxypropoxy)ethoxy)phenyl)fluorene, and so forth.

The fluorene-group-containing acrylate or methacrylate independently has a large viscosity, and the curable resin-fine particle composite material having the fine particles dispersed into such compound may further be raised in the viscosity, making it unsuitable for provision through thin film coating, printing, injection, or the like. It is therefore preferable to use one or more species of the monofunctional acrylate and/or methacrylate expressed by the general formula (5) and/or (6).

In the general formulas (5) and (6), the aromatic hydrocarbon group T may be a monocyclic or polycyclic aromatic hydrocarbon group such as phenyl group, cumylphenyl group, biphenyl group, terphenyl group, naphthalene group, dinaphthalene group, anthracene group, and pyrene group. More specifically, the monofunctional acrylate may be p-cumylphenoxyethyl acrylate, 2-(2-acryloyoloxyethoxy)biphenyl, phenoxyethyl acrylate, and so forth.

The viscosity at 25° C. of the monofunctional acrylate or methacrylate falls in the range from several tens to several thousands mPa·s (measured value obtained by using a type-E viscometer, the same will apply also hereinafter). The acryl resin material having these monomers mixed with the fluorene-group-containing acrylate or methacrylate will have a viscosity at 25° C. of 1×10² to 1×10⁵ mPa·s. The curable resin-fine particle composite material having the fine particles dispersed in this resin will have a viscosity at 80° C. of 1×10⁵ mPa·s or smaller, making it suitable for provision through thin film coating, printing, injection or the like.

Ratio of mixing of the monofunctional acrylate and methacrylate to the fluorene-group-containing acrylate and methacrylate may be 0.2 to 2. The monofunctional acrylate and methacrylate has a benzene skeleton, and is therefore excellent in the compatibility with the fluorene-group-containing acrylate and methacrylate. The monofunctional acrylate and methacrylate has a refractive index of 1.5 or larger, and may thereby maintain the refractive index of the resin-fine particle composite to a high level, even if the ratio of mixing is elevated. The monofunctional acrylate and methacrylate may therefore ensure a large degree of freedom in the amount of mixing, and specific value of the ratio of mixing may appropriately be determined depending on the viscosity and refractive index required for the curable resin-fine particle composite material. For example, for the purpose of adjusting the refractive index of the curable resin-free particle composite material to 1.58 or larger, the ratio by mass of mixing of the monofunctional acrylate and methacrylate to the fluorene-group-containing acrylate and methacrylate may preferably be adjusted to 0.2:1 to 2:1, and more preferably 0.5:1 to 1:1.

The inorganic material composing the fine particles may have a refractive index of 1.9 or larger. The inorganic material may be composed of at least one inorganic substance selected from the group consisting of titanium oxide, strontium titanate, zirconium oxide, cerium oxide, hafnium oxide, niobium pentoxide, tantalum pentoxide, indium oxide, tin oxide, indium oxide tin (ITO), zinc oxide, zinc sulfide, and simple substance of silicon. The fine particles may be configured as having two or more species of these inorganic compounds mixed therein. It is also allowable to configure the fine particles by nitrides of the metal elements composing the above-described inorganic compounds.

The fine particles may have a particle size (R) of 20 nm or smaller, preferably 2 to 20 nm, and more preferably 2 to 10 nm. The particle size of the fine particles herein means a measured value obtained by measuring the diameter of the fine particles on an image of the fine particles observed under a transmission electron microscope (TEM). If the three-dimensional geometry of the fine particles observed under the transmission electron microscope is not spherical (planar geometry is not circular), the particle size is defined by the diameter of a circle assumed as having an area equal to the area of the planar geometry of the observed fine particles. Examples of the non-spherical geometry of the fine particles include rod form, rotational ellipsoid, and rectangular parallelepiped.

A description of “the upper limit of the fine particle size (R) of the fine particles is 20 nm, and preferably 10 nm” means:

Rₐᵥₑ+2σ≦20 nm,

and preferably

Rₐᵥₑ+2σ10 nm

wherein “Rₐᵥₑ” represents an average value of the particle size (R) of the fine particles, and “σ” represents a standard deviation.

By limiting the particle size of the fine particles to 20 nm or smaller, lowering in the transmissivity of light of the resin-fine particle composite ascribable to Rayleigh scattering may be suppressed, and thereby the resin-fine particle composite which is transparent on the practical basis may be obtained. Since the transmissivity of light exponentially decreases as the light path becomes longer, so that the use of smaller fine particles is preferable. If a secondary agglomeration of the fine particles would be formed in the curable resin-fine particle composite material, the size of the secondary agglomeration now represents an effective particle size, so that in view of suppressing scattering of light, it may be necessary that the fine particles are dispersed while being treated on the surface thereof, so as to avoid formation of the secondary agglomeration.

A particle size of the fine particles of smaller than 2 nm remarkably increases the specific surface area of the fine particles, and thereby the amount of the surface treatment agents necessary for covering the surface of the fine particles becomes too large. In this case, the ratio of the surface treatment agents having small refractive indices becomes too large, so that addition of the fine particles may be unsuccessful in raising the refractive index of the curable resin-fine particle composite material to a satisfactory degree. Moreover, when the fine particle size is smaller than 2 nm, only a small amount of addition of the fine particles may remarkably increase the viscosity of the curable resin-fine particle composite material. For these reasons, the fine particle size of the fine particles may be 2 nm or larger.

The refractive index of the curable resin-fine particle composite material of an embodiment may be adjustable by the amount of filling of the fine particles, based on the thought below. That is, the refractive index of the curable resin-fine particle composite material having the high-refractive-index fine particles uniformly dispersed in the resin material may be estimated based on the relational expression (1) below, based on the Maxwell-Garnet theory (see C. F. Bohren and D. R. Huffman, “Adsorption and Scattering of Light by Small Particles”, John Wiley & Sons, New York, 1983, pp. 213). It is to be understood that the relational expression (1) assumes that there are no surface treatment agents covering the fine particles.

$${ɛ}_{av} = {ɛ}_{m} [ 1 + \frac{3 η ( \frac{{ɛ}_{p} - {ɛ}_{m}}{{ɛ}_{p} + 2 {ɛ}_{m}} )}{1 - η ( \frac{{ɛ}_{p} - {ɛ}_{m}}{{ɛ}_{p} + 2 {ɛ}_{m}} )} ] \qquad ( 1 )$$

(wherein, εₐᵥ: dielectric constant of the curable resin-fine particle composite material;
εₚ: dielectric constant of the fine particles;
εₘ: dielectric constant of the resin; and
η: ratio of volume filling by the fine particles).

Since refractive index n is expressed as n=ε^{1/2}, the refractive index of the curable resin-fine particle composite material may be estimated using the expression (1).

Because the curable resin-fine particle composite material of an embodiment is adjustable in the refractive index based on the amount of filling of the fine particles, it is good enough to preliminarily select a material for composing the fine particles, and further the amount of filling thereof, depending on a target refractive index of the curable resin-fine particle composite material. The amount of filling of the fine particles in the curable resin-fine particle composite material of an embodiment may be 1 to 70 wt %, preferably 5 to 50 wt %, and more preferably 10 to 40 wt %. The amount of filling of the fine particles exceeding 70 wt % may raise the viscosity of the curable resin-fine particle composite material, and may make it unsuitable for applications such as thin film coating, printing, injection and so forth.

The curable resin-fine particle composite material of an embodiment is transparent, lightweight inexpensive and excellent in the processability and mass productivity similarly to the material composed of the resin only, and has a larger refractive index than the material composed of the resin only, so that it may preferably be adoptable as a filler for the light emitting device, aimed at providing a refractive index adjusting component on the light path of the light emitting device, and may improve the efficiency of light extraction from the light emitting device.

The curable resin-fine particle composite material may contain various additive monomers if necessary, for the purpose of adjusting the rate of curing and viscosity of the resin material in the composite material, and refractive index, transparency, light resistance, heat resistance and so forth attainable by the curing. It is, however, desirable that the additive monomers do not impair the dispersibility of the fine particles.

For example, aromatic vinyl monomer such as styrene may be mixed, for the purpose of lowering the viscosity of the curable resin-fine particle composite material. It is also allowable to mix butyl acrylate, 2-ethylhexyl acrylate, 2-methoxy acrylate, 3-methoxybutyl acrylate and so forth, in order to add flexibility to the resin-fine particle composite.

It is also allowable to add an additive monomer for lowering the cutoff frequency, in order to improve the transparency of the resin-fine particle composite. Lowering in the cutoff frequency makes the resin-fine particle composite transparent to UV light or blue light emitted from the LED, and prevents these lights from being absorbed by the resin-fine particle composite. This is preferable because loss of luminance may successfully be avoidable, the resin-fine particle composite may be prevented from degrading due to these lights over a long period, and thereby the transparency may be maintained in a stable manner. Examples of the additive monomers include cyclohexyl acrylate, dicyclopentenyl acrylate, tricyclodecanyl acrylate, isobornyl acrylate, and adamantyl acrylate, and methacrylates having the same ester bonds.

Hardeners adoptable to the curable resin-fine particle composite material include radical-base hardeners such as peroxides, azo compounds and so forth, and UV hardeners. The amount of mixing thereof is preferably 0.1 to 5 parts by weight of the total amount, or per 100 parts by weight, of the monomer. Other various additives other than those described in the above, such as polymerization inhibitor, may be added to the curable resin-fine particle composite material. For example, hydroquinone, methoquinone, dibutylhydroxytoluene (BHT) or the like may be added as the polymerization inhibitor, typically to an amount of 25 to 1000 ppm.

In the method of producing the curable resin-fine particle composite material of an embodiment, the surface treatment of the fine particles using the first surface treatment agent to the third surface treatment agent may be proceeded in a liquid phase. More specifically, first, the fine particles are suspended in an organic solvent, and then the first surface treatment agent to the third surface treatment agent are added thereto. The organic solvent may be anything provided that it can dissolve the first surface treatment agent to the third surface treatment agent. The amount of addition of the first surface treatment agent to the third surface treatment agent is preferably slightly excessive to the amount allowing formation of a single layer of covering around the surface of the fine particles.

Next, the mixture is processed using a known dispersion machine. By this process, the secondary agglomeration of the fine particles may be cracked. The fine particles synthesized by the liquid-phase process and remain undried may be preferable, because they cause the secondary agglomeration only at a slow rate, and may readily be cracked. The first surface treatment agent to the third surface treatment agent is adsorbed to the surface of the fine particles before the cracking in the dispersion machine. The temperature of cracking is preferably adjusted to the range from room temperature to 150° C.

Thereafter, the fine particles covered with the first surface treatment agent to the third surface treatment agent are recovered in a form of dispersion liquid having the fine particles uniformly dispersed therein, or in a form of precipitate. Whether the fine particles are recovered in a form of dispersion liquid or precipitate depends on types of the organic solvent to be adopted. The fine particles may be recovered in a form of precipitate, also by adding a poor solvent to thus obtained dispersion liquid so as to allow the fine particles to re-agglomeration, followed by centrifugation. When the fine particles are recovered in a form of precipitate, precipitation by centrifugal separation and rinsing using an organic solvent for rinsing are repeated, so as to remove excessive portions of the first surface treatment agent to the third surface treatment agent. After the recovery, the precipitate may be dried under reduced pressure.

In the method of producing the curable resin-fine particle composite material of an embodiment, mixing of the fine particles treated on the surface thereof with the first surface treatment agent to the third surface treatment agent and the curable resin material may be proceeded by either of two following methods descried below. The first method is that the fine particles are dispersed in a good solvent which can dissolve the curable resin material and also the additives optionally added thereto, mixed with the resin material and additives, stirred, and thereafter only the solvent is removed under heating and under reduced pressure. In this process, the resin material and the additives hardly vaporize due to their low vapor pressure. The second method is that the dried fine particles and the resin material and the additives are directly mixed, and homogeneously mixed using a publicly-known kneader.

The curable resin-fine particle composite material added with the additives may be cured by heating at 80° C. to 150° C., or by irradiating UV radiation. The second surface treatment agent has a carbon-carbon double bond at the terminal of the non-substituted or substituted hydrocarbon group R², so that, if the curable resin material is a resin material curable by addition polymerization, a part of molecules of which may be integrated with the curable resin material through copolymerization. In this process, the curing proceeds while maintaining dispersibility of the fine particles in the curable resin-fine particle composite material, and thereby the fine particles are immobilized.

The optical material of an embodiment may be used as the refractive index adjusting material, optical lens material, optical waveguide material, and anti-reflective material. For example, as the refractive index adjusting material, the optical material may be used as a filler for light emitting device.

The light emitting device of an embodiment may have the light emitting element, and the sealing member sealing the light emitting element, wherein the sealing member is preferably composed of the optical material. In this case, the light emitting element may be disposed in a recess of a reflective cup, the sealing member may be disposed in contact with the light emitting element to fill the recess. The device may be configured so that light emitted from the light emitting element is extracted through the optical material composing the sealing member to the outside, directly therethrough, or after being reflected on the wall surface of the reflective cup.

Alternatively, the light emitting device may have the light emitting element, the sealing member sealing the light emitting element, and a filler filling the gap residing between the light emitting element and the sealing member. In the light emitting device, the filler may be composed of the optical material.

The light emitting device may have the light emitting element disposed in a recess of a reflective cup, the filler may be disposed in contact with the light emitting element to fill the recess, and the sealing member may be disposed to be contact with the filler, the device being configured so that light emitted from the light emitting element is extracted through the optical material composing the filler to the outside, directly therethrough, or after being reflected on the wall surface of the reflective cup. The light emitting device herein is used as a light source emitting light mainly frontward.

Alternatively, the sealing member may have an axi-symmetrical geometry having a circular bottom surface, a convex-lens-form side face and a concave-lens-form top surface, the bottom surface being provided with a recess, the light emitting element being disposed in the recess at the center position of the bottom surface, the device being configured so that light emitted from the light emitting element is extracted through the side face to the outside, mainly directly therethrough, or after being reflected on the top surface. The light emitting device herein is used as a light source emitting light mainly sideward.

Alternatively, the light emitting device may have the light emitting element, the sealing member sealing the light emitting element, and a filler filling the gap between the light emitting element and the sealing member, in which the filler and the sealing member are composed of the optical material.

In these light emitting devices, the anti-stain layer may be provided to the surface of the sealing member. The anti-stain layer may be composed of a fluorine-containing resin which is exemplified by an alkoxysilane compound having a perfluoroether group.

Paragraphs below will further specifically explain preferred embodiments referring to the attached drawings, without limiting the present application.

### Embodiment 1

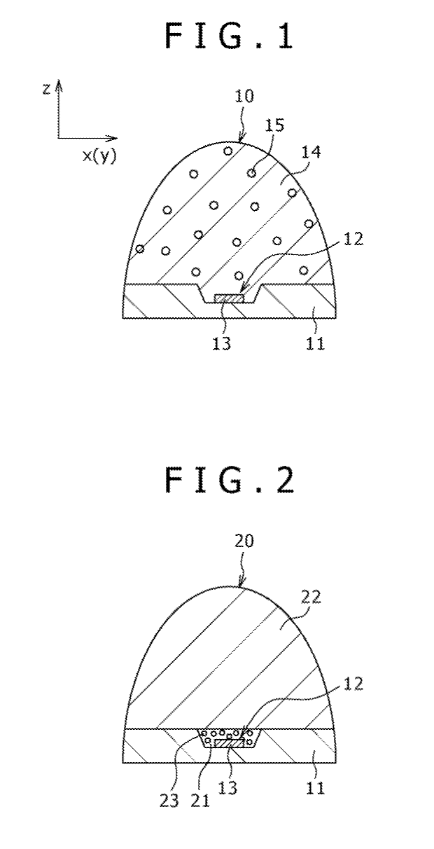

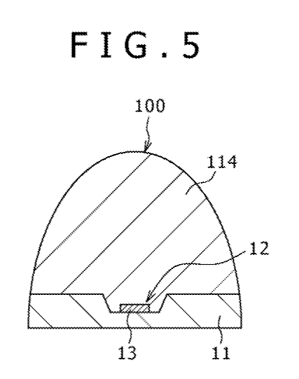

FIG. 1 is a sectional view schematically showing a structure of a light emitting device 10 according to Embodiment 1. The light emitting device 10 corresponds to the light emitting devices described in Claims 30 and 31, and has a structure similar to that of the conventional general light emitting device 100 shown in FIG. 5, in which a light emitting element 13 is disposed in a recess 12 of a reflective cup 11, a sealing member 14 is disposed as being brought into contact with the light emitting element 13 and so as to fill the recess 12, thereby the device is configured so that light emitted from the light emitting element 13 is extracted through the sealing member 14 to the outside, directly therethrough, or after being reflected on the wall surface of the reflective cup 11. The sealing member 14 is disposed on and above the light emitting element 13, with appropriate geometry and thickness depending on purposes of the light emitting device 10. For example, as shown in FIG. 1, it is disposed as a shell-formed lid of the recess 12 of the cup 11.

The characteristic feature of the light emitting device 10 resides in that an optical material composing the sealing member 14 is the optical material composed of the resin-fine particle composite. The optical material is transparent and has a large refractive index by virtue of addition of the fine particles composed of a high-refractive-index material, so that total reflection of light emitted from the light emitting element 13 on the interface between the light emitting element 13 and the sealing member 14 may be suppressed, and thereby the efficiency of light extraction is improved as compared with that of the conventional light emitting device 100.

The light emitting element 13 composing the light emitting device 10 may be exemplified by light emitting diode (LED) and semiconductor laser. The light emitting diode herein includes those emitting red light (at a wavelength of 640 nm, for example), those emitting green light (typically at a wavelength of 530 nm), and those emitting blue light (at a wavelength of 450 nm, for example), white light emitting diode (those emitting white light by combining an ultraviolet or blue emission diode with phosphor fine particles, for example). The light emitting diode may have so-called, face-up structure, or may have flip-chip structure. In other words, the light emitting diode may be composed of a substrate, and a light emitting layer formed on the substrate, and may be configured as emitting light from the light emitting layer to the outside, or as emitting light from the light emitting layer through the substrate to the outside.

More specifically, the light emitting diode (LED) has, for example, a first cladding layer composed of a first-conductivity-type (n-type, for example) compound semiconductor layer formed on the substrate, an active layer formed on the first cladding layer, and a second cladding layer composed of a second-conductivity-type (p-type, for example) compound semiconductor layer formed on the active layer, and also has a first electrode electrically connected to the first cladding layer, and a second electrode electrically connected to the second cladding layer. The layers composing the light emitting diode may be selected from known compound semiconductor material layers, depending on desired wavelength of emission.

Alternatively, the light emitting device may be configured as being attached with a light extraction lens as described later in Embodiment 3, in place of using the sealing member 14. Alternatively, an anti-stain layer may be provided to the surface of the sealing member 14 as described later.

### Embodiment 2

FIG. 2 is a sectional view schematically showing a structure of a light emitting device 20 according to Embodiment 2 of an embodiment. In the light emitting device 20, the light emitting element 13 is disposed in a recess 12 of a reflective cup 11, the filler 21 is disposed as being brought into contact with the light emitting element 13 and so as to fill the recess 12, and the sealing member 22 is disposed as being brought into contact with the filler 21, thereby the device is configured so that light emitted from the light emitting element 13 is extracted through the filler 21 and the sealing member 22, directly therethrough, or after being reflected on the wall surface of the reflective cup 11.

The light emitting device 20 may be characterized in that an optical material composing the filler 21 is the optical material composed of the resin-fine particle composite. The optical material is transparent and has a large refractive index by virtue of addition of the fine particles composed of a high-refractive-index material, so that total reflection of light emitted from the light emitting element 13 on the interface between the light emitting element 13 and the filler 21 may be suppressed, and thereby the efficiency of light extraction is improved.

Moreover, by virtue of a desirable level of hardness of the optical material, stress distortion may be suppressed to a low level, even if the light emitting element 13 is elevated in temperature during operation. For example, there is no fear of stress, causative of breakage of a bonding wire (not shown) connecting an electrode of the light emitting element 13 and an interconnect electrode, formed as being buried in the filler 21, applied from the optical material. The optical material is excellent in light resistance and heat resistance. As a consequence, the light emitting device 20 may be provided with a high level of durability, by using the optical material.

The sealing member 22 is disposed on or above the light emitting element 13, with appropriate geometry and thickness depending on purposes of the light emitting device 20. For example, as shown in FIG. 2, it is disposed as a shell-formed lid of the recess 12 of the cup 11, so as to fill the filler 21. The sealing member 22 is composed of a transparent material (for example, polycarbonate resin having a refractive index of 1.6), and may be composed of a high-refractive-index material equivalent to the optical material composing the filler 21, in view of suppressing reflection of light on the interface with the filler 21.

The high-refractive-index material is exemplified by high-refractive-index plastic materials such as Prestige (trade name, refractive index=1.74) produced by Seiko Optical Products Co., Ltd., ULTIMAX V AS 1.74 (trade name, refractive index=1.74) produced by Showa Opt Co., Ltd., and NL5-AS (trade name, refractive index=1.74) from Nikon-Essilor Co., Ltd.; glass materials such as NBFD11 (refractive index n=1.78), M-NBFD82 (refractive index n=1.81), and M-LAF81 (refractive index n=1.731) produced by HOYA Corporation; and inorganic dielectric materials such as KTiOPO₄ (refractive index n=1.78), and lithium niobate [LiNbO₃] (refractive index n=2.23).

Still alternatively, materials composing the sealing member 22 may be exemplified by epoxy-base resin, silicone resin, acryl resin, acryl resin, polycarbonate resin, spiro compound, polymethyl methacrylate and copolymer thereof, diethylene glycol bisacryl carbonate (CR-39), polymer and copolymer of urethane-modified monomer of mono(meth)acrylate of (brominated) bisphenol-A, polyester-base resin (for example, polyethylene terephthalate resin, polyethylene naphthalate resin), unsaturated polyester, acrylonitrile-styrene copolymer, vinyl-chloride-base resin, polyurethane-base resin, and polyolefin-base resin. It is good enough that the sealing member is composed of at least one of these materials. In consideration of heat resistance, aramid-base resin may be adoptable. In this case, the upper limit of the heating temperature in the process of forming the anti-stain layer composed of a fluorine-containing resin described later may be set as high as 200° C. or above, and thereby degree of freedom in selection of the fluorine-containing resin may be improved.

Alternatively, the light emitting device may be configured as being attached with a light extraction lens as described later in Embodiment 3, in place of using the sealing member 22. Alternatively, an anti-stain layer may be provided to the surface of the sealing member 22 as described later.

### Embodiment 3

For example, in the light emitting devices 10 and 20 explained in Embodiment 1 and 2, light emitted from the light emitting element 13 may be modified in the path due to reflection on the reflective cup 11, and convex lens effects of the sealing members 14 and 22, so that most portion of light emitted from the light emitting devices 10 and 20 to the outside is directed to the direction (direction of z-axis) normal to the surface of emission, whereas only a small portion is directed to the direction (directions of x-axis and y-axis) in parallel with the surface of emission. If this sort of light emitting device is applied to a surface light source unit such as a backlight unit for liquid crystal display devices, non-uniformity in luminance of the surface light source unit may arise, due to shortage of light spreading in the in-plane direction.

The light emitting device according to Embodiment 3 is aimed at avoiding the phenomenon described in the above, and is configured so that most portion of light emitted from the light emitting device to the outside is directed to the directions (directions of x-axis and y-axis) in parallel with the surface of emission. The light emitting device may be adoptable to surface light source unit such as backlight unit for liquid crystal display devices.

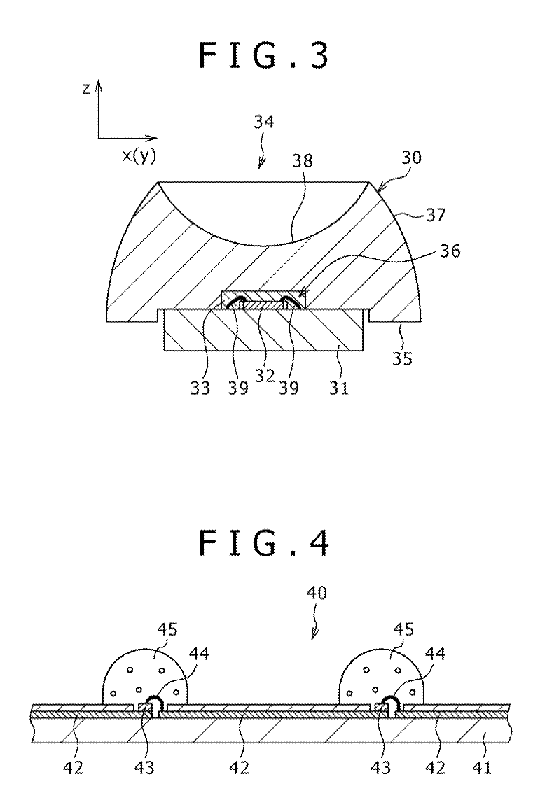

FIG. 3 is a sectional view schematically showing a structure of a light emitting device 30 according to Embodiment 3. In the light emitting device 30, a light emitting element (light emitting diode) 32 is disposed on a substrate 31, and wires 39 connecting the interconnect portions (not shown) provided to the substrate 31 and the light emitting element 32 are formed. A light extraction lens 34 is disposed on the light extraction side of the light emitting element 32, to the bottom surface 35 of which a recess 36 is provided. The light emitting element 32 is housed in the recess 36, and a gap between the light emitting element 32 and the light extraction lens 34 is filled with a filler 33.

The light extraction lens 34 has an axi-symmetrical geometry, has a circular bottom surface 35, a side face 37 and a top surface 38, and at the center of the bottom surface 35, a surface emission unit (light emitting element 32) of a finite size is disposed (for more details about the light extraction lens 34, see PCT Publication WO 2006/059728 published on Jun. 8, 2006. The published PCT application corresponds to Japanese Patent Application No. 2005-300117 filed in the Japanese Patent Office on Oct. 14, 2005). Examples of materials composing the light extraction lens 34 include those composing the sealing member 22 described previously in Embodiment 2.

Light emitted upward (direction of z-axis) from the light emitting element 32 passes through the filler 33 and the light extraction lens 34, and reaches the top surface 38 of the lens 34 which forms the interface between the light extraction lens 34 and the outside. Components of light incident on the top surface 38 at small angles of incidence are refracted at the top surface 38, and modify their directions of path so as to divert the flux by the concave lens effect, but are emitted upward anyway. On the other hand, components of light incident on the top surface 38 at larger angles of incidence cause total reflection on the top surface 38, and modify their directions of path mainly into directions in parallel with the surface of emission (directions of x-axis and y-axis), and are emitted through side face 37 to the outside. Components of light emitted from the light emitting element 13 to the side face 37 of the light extraction lens 34 pass through the filler 33 and the light extraction lens 34, and come into the side face 37 at small angles of incidence, so that the components propagate almost straightly causing only a small refraction, and then emitted to the outside. As a consequence, most components of light emitted from the light emitting element 13 are extracted through the side face 37 into the outside, directly therethrough, or after being reflected by the top surface 38 of the lens 34.

The light emitting device 30 of this Embodiment is characterized in that the optical material composing the filler 33 is the optical material composed of the resin-fine particle composite. The optical material is transparent and has a large refractive index by virtue of addition of the fine particles (not shown) composed of a high-refractive-index material, so that total reflection of light emitted from the light emitting element 32 on the interface between the light emitting element 32 and the filler 33 may be suppressed, and thereby the efficiency of light extraction is improved.

Further explanation on essential features of the light extraction lens 34 will be given below. Assuming a cylindrical coordinate (r,φ,z) having the origin at the center of the bottom surface 35, and the z-axis defined by the normal line fallen on the center of the bottom surface 35,

the top surface 38 is composed of an aspherical surface axi-symmetrical to the z-axis, allowing thereon total reflection of a part of components of emitted light having polar angles smaller than the polar angle Θ₀ at the portion where the side face 37 and the top surface 38 abut, out of all components emitted at half of total solid angles; and

the side face 37 is composed of an aspherical surface axi-symmetrical to the z-axis, allowing therethrough transmission of components of emitted light having polar angles larger than the polar angle Θ₀, and components of emitted light totally reflected on the top surface 38, out of all components emitted at half of total solid angles;

assuming z ordinate at the portion where the side face 37 and the top surface 38 abut as z₁, in function r=fₛ(z) with a variant z for expressing the side face 37 composed of an aspherical surface, the function r=fₛ(z) monotonously increases as z decreases in the closed interval of 0≦z≦z₁, and has at least one point where the absolute value of second-order differential of z becomes maximal in the closed interval. The light extraction lens is, however, not limited by the light extraction lens 34 shown in FIG. 2, allowing any light, extraction lenses of any configurations or any structures.

### Embodiment 4

FIG. 4 is a sectional view schematically showing a structure of a light emitting device 40 according to Embodiment 4. The light emitting device 40 includes one or more light emitting elements 43 disposed on a wiring substrate 41, and sealing members 45 sealing the light emitting elements 43 are provided on the wiring substrate 41. Each light emitting element 43 is a light emitting diode (LED) chip, for example, and an electrode (not shown) of each light emitting element 43 is connected to a wiring electrode of an interconnect layer 42 directly, or indirectly through a bonding wire 44 or a solder bump.

The light emitting device 40 is characterized in that, similarly to as Embodiment 1, the optical material composing the sealing member 45 is the optical material composed of the resin-fine particle composite. The optical material is transparent and has a large refractive index by virtue of addition of the fine particles composed of a high-refractive-index material, so that total reflection of light emitted from the light emitting element 43 on the interface between the light emitting element 43 and the sealing member 45 may be suppressed, and thereby the efficiency of light extraction is improved as compared with that of the conventional light emitting device 100.

A single wiring substrate 41 may have a set of a red LED, a green LED and a blue LED corresponded to three principal colors disposed thereon, so as to allow generation of white light based on mixing of lights emitted from these LEDs. The light emitting device 40 having the LED sets arranged in an array or in a matrix may be used as a linear or planar light source capable of emitting white light. The linear or planar light sources 40 further arranged in an array or in a matrix may be used as a back light unit for transmission-type color liquid crystal display panels.

The light emitting devices 10 to 40 shown in Embodiments 1 to 4 may be used in any fields where emission of light is required, wherein such fields include backlight of liquid crystal display devices [including surface-emission light source unit, available in two types of straight-under type and edge-light (also referred to as side-light) type], lighting apparatuses and lamps for automobile, train, marine vessel, aircrafts and so forth (for example, head light, tail light, high-mount braking light, small light, turn signal lamp, fog light, room light meter panel light, light sources built in various buttons, winker lamp, emergency lamp, emergency exit guide lamp, etc.), various lighting apparatuses and lamps in buildings (exterior light, room light, lighting goods, emergency lamp, emergency exit guide lamp, etc.), street lamp, traffic signal, signboard, various indicators used for machine, apparatus and so forth, and illumination apparatuses and natural lighting unit.

It is also allowable to form an anti-stain layer on the surfaces of the sealing members 14 and 22, and the light extraction lens 34. Thickness of the anti-stain layer is not specifically limited, but preferably adjusted to 0.5 to 50 nm, and more preferably 1 to 20 nm in view of transparency. Materials for composing the anti-stain layer are preferably fluorine-containing resins and so forth, and basically those having a perfluoropolyether group, and more preferably alkoxysilyl group, will suffice.

Materials for composing the anti-stain layer are not limited intrinsically in terms of molecular structure except for perfluoropolyether group, but on the practical basis, there are some limitations arisen from requirements from the viewpoint of readiness in synthesis, or feasibility. More specifically, the fluorine-containing resin suitable for composing the anti-stain layer may be exemplified by alkoxysilane compound having a perfluoropolyeter group expressed by the general formula (7) below:

R_{f}(CO—U—R⁴—Si(OR⁵)₃)ⱼ (7)

(wherein R_{f} represents a perfluoropolyether group, U represents a divalent atom or group, R⁴ represents an alkylene group, R⁵ represents an alkyl group, and j=1 or 2).

Molecular weight of the alkoxysilane compound expressed by the general formula (7) is not specifically limited, wherein the number-average molecular weight falls in the range from 4×10² to 1×10⁴, and preferably from 5×10² to 4×10³, in view of stability and handlability.

The perfluoropolyether group R_{f} is a monovalent or divalent perfluoropolyether group, wherein specific structures of which are given by the general formulas (8) to (11), but not limited thereto. In the general formulas (8) to (11), each of p and q is preferably an integer from 1 to 50, and each of k to n represents an integer of 1 or larger. A value of 1/m preferably falls in the range from 0.5 to 2.0.

If j=2, the perfluoropolyether group R_{f} may be exemplified by those expressed by the general formula (8) below:

—CF₂—(OC₂F₄)ₚ—(OCF₂)_{q}—OCF₂— (8)

If j=1, the perfluoropolyether group R_{f} in the general formula (7) may be exemplified by those expressed by the general formulas (9) to (11) below. It is not always necessary that hydrogen atoms of all alkyl groups are substituted by fluorine atoms, allowing hydrogen atoms partially remained.

F(CF₂CF₂CF₂)ₖ— (9)

CF₃(OCF(CF₃)CF₂)ₗ(OCF₂)ₘ— (10)

F(CF(CF₃)CF₂)ᵤ— (11)

As the materials for composing the anti-stain layer containing perfluoropolyether group, it is also allowable to use, for example, perfluoropolyether having a polar group at the terminal thereof (see Japanese Unexamined Patent Application Publication (KOKAI) No. 9-127307), a composition for forming an anti-stain film containing an alkoxysilane compound having a perfluoropolyether group of a specific structure (see Japanese Unexamined Patent Application Publication (KOKAI) No. 9-255919), and surface modifires obtained by combining alkoxysilane compounds having perfluoropolyether groups with various compounds (see Japanese Unexamined Patent Application Publication (KOKAI) Nos. 9-326240, 10-26701, 10-120442, and 10-148701).

U represents a divalent atom or atomic group coupling a perfluoropolyether group R_{f} and R⁴ which is not specifically limited, but preferably an atom or atomic group other than carbon, such as —O—, —NH—, —S—, from the synthetic viewpoint, R⁴ represents a hydrocarbon group, and the number of carbon atoms preferably falls in the range from 2 to 10. More specifically, R⁴ may be exemplified by alkylene groups such as methylene group, ethylene group, and propane-1,3-diyl group, and by phenylene group. R⁵ represents an alkyl group composing an alkoxy group, and is generally exemplified by those having three or smaller number of carbon atoms, such as isopropyl group, propyl group, ethyl group, and methyl group. The number of carbon atoms may be 4 or larger.

When the anti-stain layer is formed, a fluorine-containing resin (for example, alkoxysilane compound represented by the general formula (7)) is used generally as being dissolved in a solvent. Although the solvent used herein is not specifically limited, it may be necessary to determine the species considering the stability of the composition, wettability to the surface of the sealing member, volatility and so forth in the practical use. More specifically, alcohol-base solvents such as ethanol, ketone-base solvents such as acetone, and hydrocarbon-base solvents such as hexane may be exemplified, wherein two or more species of them may be mixed and used as a solvent.

Alternatively, the solvent for dissolving the fluorine-containing resin may be determined considering the stability of the composition, wettability to the surface of the sealing member, volatility and so forth in the practical use, and fluorinated hydrocarbon-base solvents are preferably used. The fluorinated hydrocarbon-base solvents are compounds having fluorine atom(s) substituted on a part of, or all of the hydrogen atoms of hydrocarbon-base solvents such as aliphatic hydrocarbon, cyclic hydrocarbon and ethers. Examples of them include ZEORORA-HXE (trade name, b.p. 78° C.) from ZEON Corporation, perfluoroheptane (b.p. 80° C.), perfluorooctane (b.p. 102° C.), hydrofluoropolyethers such as H-GALDEN-ZV75 (b.p. 75° C.), H-GALDEN-ZV85 (b.p. 85° C.), H-GALDEN-ZV100 (b.p. 95° C.), H-GALDEN-C (b.p. 130° C.), H-GALDEN-D (b.p. 175° C.), or perfluoropolyethers such as SV-110 (b.p. 110° C.), SV-135 (b.p. 135° C.) and so forth under trade names from Ausimont Inc., and perfluoroalkane such as FC Series from Sumitomo-3M Limited. Of these fluorinated hydrocarbon-base solvents, it is preferable to select those having boiling points from 70 to 240° C. as a solvent used for dissolving the fluorine-containing compounds, in view of obtaining the anti-stain layer uniform in the texture and thickness, wherein it is particularly preferable to select hydrofluoropolyether (HFPE) or hydrofluorocarbon (HFC), and to use them independently, or in a form of mixture of two or more species. Too low boiling point may be more causative of non-uniformity in coating, whereas too high boiling point may make the layer less likely to dry, and may make formation of a uniform anti-stain layer difficult. HFPE and HFC are excellent in solubility into the fluorine-containing compounds, and thereby an excellent surface of coating may be obtained.

The anti-stain layer may be formed on the surface of the sealing member, by coating a solution containing the fluorine-containing resin dissolved and diluted in a solvent on the surface of the sealing member, and then by allowing the solvent to vaporize typically under heating, and allowing bonding to produce between a material composing the sealing member and the fluorine-containing resin composing the anti-stain layer. Various methods of coating generally adopted may be applicable herein, wherein spin coating and spray coating may preferably be used. From the viewpoint of workability, one adoptable method may be such as coating the liquid as being immersed into some material such as paper, cloth and so forth. The heating temperature herein may be selected considering the heat resistance or the like of the sealing member, and is appropriately adjusted to 30 to 80° C. when polyethylene terephthalate resin is used as the sealing member.

The alkoxysilane compound expressed by the general formula (7) is given with water repellency by virtue of the perfluoropolyether groups contained in the molecule, and is improved in the anti-stain property. As a consequence, formation of the anti-stain layer containing the alkoxysilane compound may impart the surface of the sealing member with properties of wear resistance and anti-stain.

It is preferable herein to add at least one material selected from the group consisting of acid, base, phosphate ester and acetyl acetone, as a catalyst for accelerating reaction between the material composing the sealing member and the material composing the anti-stain layer, to the material composing the anti-stain layer. The catalyst may be exemplified typically by acids such as hydrochloric acid, bases such as ammonia, and phosphate ester such as dilauryl phosphate. Amount of addition of the catalyst may be exemplified by 1×10⁻³ to 1 mmol/L. For the case where acid or base is added, addition of a carbonyl compound such as acetyl acetone may enhance the reactivity, so that addition of a carbonyl compound to the composition for forming the anti-stain layer is recommended. Amount of addition of such carbonyl compound may be adjusted to 1×10⁻¹ to 1×10²⁻³ to 1 mmol/L or around. By adding the catalyst in this way, a strong bond may be formed between the sealing member and the anti-stain layer even at a lower temperature of heating (drying). As a consequence, the producing process may be more advantageous, and may have larger range of selection of the materials composing the sealing member.

A practical case of forming the anti-stain layer on the surface of the sealing member 22 of the light emitting device 20 shown in Embodiment 2 will be explained next.

As the fluorine-containing resin, 2 parts by weight of an alkoxysilane compound (mean molecular weight of approximately 4000) expressed by the general formula (12) below:

R_{f}(CO—NH—C₃H₆—Si(OCH₂CH₃)₃)₂ (12)

having perfluoropolyether groups on both terminals, was dissolved into 200 parts by weight of hydrofluoropolyether (trade name H-GALDEN, produced by Solvay Solexis), which is a fluorine-containing solvent having a boiling point of 130° C., and was further added with 0.08 parts by weight of perfluoropolyether phosphate ester as a catalyst, and the obtained homogeneous solution was further filtered through a membrane filter, to thereby obtain a composition for forming the anti-stain layer. The composition for forming the anti-stain layer was then coated on the surface of the sealing member 22 using a spraying tool, the coating was allowed to dry at 70° C. for 1 hour, to thereby obtain the light emitting device 20 having the anti-stain layer formed on the surface of the sealing member 22.

The sealing member 22 of thus obtained light emitting device 20 was then dusted with corn starch, and the corn starch was then removed using an air gun. Observation of the surface of the sealing member 22 under an optical microscope revealed that the corn starch was completely removed.

Another light emitting device 20 was obtained similarly to as described in the above, except that a resin (mean molecular weight of approximately 2000) represented by the general formula (13) below was used as the fluorine-containing resin:

R₁═—CH₂CF₂(OC₂F₄)ₚ(OCF₂)_{q}OCF₂— (13)

The sealing member 22 of thus-obtained light emitting device 20 was dusted with corn starch, and the corn starch was then removed using an air gun. Observation of the surface of the sealing member 22 under an optical microscope revealed that the corn starch was completely removed.

Still another light emitting device 20 was obtained similarly to as described in the above, except that a resin (mean molecular weight of approximately 650) expressed by the general formula (14) below was used as the fluorine-containing resin:

CF₃(CF₂)₈CH₂Si(OC₂H₅)₃ (14)

The sealing member 22 of thus-obtained light emitting device 20 was dusted with corn starch, and the corn starch was then removed using an air gun. Observation of the surface of the sealing member 22 under an optical microscope revealed that the coin starch was completely removed.

### EXAMPLES

Without limiting the present application, Examples 1 to 6 explain exemplary cases according to embodiments where zirconium oxide ZrO₂ nano-particles, as the fine particles, was treated with the first surface treatment agent to the third surface treatment agent, then mixed with a fluorene group-containing acryl resin material as the curable resin material, to thereby form a composite material having the ZrO₂ nano-particles dispersed in the fluorene group-containing acryl resin material as the above-described curable resin-fine particle composite material, and refractive index and transmissivity of light were measured.

### Example 1

### (1) Surface Treatment of Nano-Particles

Ten grams of ZrO₂ nano-particles having a fine particle size of 8 nm, synthesized by the sol-gel process, were added to toluene, and the mixture was further added with 10 g of stearic acid, 20 mL of methacrylic acid, and 50 g of benzoic acid, and stirred using a disper at room temperature. The mixture was then added with ethanol, centrifuged so as to precipitate the nano-particles, and the precipitate was collected. The precipitate was added with ethanol, crushed using a disper, precipitated again by centrifugation, and then collected. These process steps of crushing and centrifugation were repeated three times, and the precipitate was collected, to thereby obtain the ZrO₂ nano-particles having the surface thereof coated with stearic acid, methacrylic acid and benzoic acid. It is to be understood that “the fine particle size of the ZrO₂ nano-particles is 8 nm” means that a value of Dₐᵥₑ+2σ, where Dₐᵥₑ is mean fine particle size and σ is standard deviation, never exceeds 8 nm.

### (2) Preparation of Fluorene Group-Containing Acryl Resin Material

Fifty parts by weight of 9,9′-bis(4-(2-acryloxyethoxy)phenyl)fluorene and p-cumylphenoxyethyl acrylate were mixed, homogeneously mixed at 60° C., and cooled to 40° C. The mixture was then added with 1 part by weight of a hardener (perhexyl ND (trade name), from NOF Corporation), homogenously dispersed using a planetary mixer, to thereby obtain a fluorene group-containing acryl resin material. Viscosity of thus-obtained resin material was found to be 4500 mPa□s, and refractive index was found to be 1.58.

### (3) Preparation of Curable Resin-Fine Particle Composite Material

A predetermined amount of the ZrO₂ nano-particles obtained in (1) was added to toluene, and dispersed into toluene using a disper. The dispersion liquid and a predetermined amount of the fluorene group-containing acryl resin obtained in (2) in the above were mixed, and homogenously mixed using a defoaming mixer. Toluene was then removed from the mixed liquid using an evaporator (set temperature of 40° C.), to thereby obtain a curable resin-fine particle composite material containing the ZrO₂ nano-particles having the surface thereof coated with stearic acid, benzoic acid, and methacrylic acid, as being dispersed in the fluorene group-containing acryl resin material obtained in (2) in the above.

Refractive index of the above-described curable resin-fine particle composite material was measured using a publicly-known Abbe refractometer (Model NAR-4T, from ATAGO Co., Ltd.). Measurement was made at a wavelegth of sodium D-line (589 nm) at 25° C. Transmissivity of light of the above-described curable resin-fine particle composite material was also measured using an UV-visible spectrophotometer (Model U-3410, from Hitachi High-Technologies Corporation), using a quartz cell of 0.5 mm in light path, at a wavelength range from 380 to 750 nm. Results of evaluation based on the measurement were shown in Table 1.

### Example 2

In Example 2, 10 g of ZrO₂ nano-particles same as those used in Example 1 were added to ethanol, the mixture was further added with 10 g of stearic acid, 20 mL of methacrylic acid, and a 25 g of biphenyl-4-carboxylic acid, and then stirred using a disper at room temperature. The mixture was then added with ethanol, centrifuged so as to precipitate the nano-particles, and the precipitate was collected. The precipitate was added with ethanol, crushed using a disper, precipitated again by centrifugation, and then collected. These process steps of crushing and centrifugation were repeated three times, and the precipitate was collected, to thereby obtain the ZrO₂ nano-particles having the surface thereof coated with stearic acid, methacrylic acid and biphenyl-4-carboxylic acid. The surface of the ZrO₂ nano-particles herein was coated with the surface treatment agents in ethanol, because biphenyl-4-carboxylic acid is insoluble to toluene but soluble to ethanol. Except for this, a curable resin-fine particle composite material was produced similarly to as described in Example 1, and then evaluated. Results were shown in Table 1.

### Example 3

In Example 3, the surface treatment of the ZrO₂ nano-particles was carried out using 10 g of dodecanoic acid, 10 mL of methacrylic acid, and 10 g of biphenyl-4-carboxylic acid 10 g. Except for this, a curable resin-fine particle composite material was produced similarly to as described in Example 2, and then evaluated. Results were shown in Table 1.

### Example 4

In Example 4, the surface treatment of the ZrO₂ nano-particles was carried out using 10 mL of methacrylic acid and 25 g of 2-naphthoic acid, in place of 20 mL of methacrylic acid and 25 g of biphenyl-4-carboxylic acid used in Example 2. Except for this, a curable resin-fine particle composite material was produced similarly to as described in Example 2, and then evaluated. Results were shown in Table 1.

### Example 5

In Example 5, the surface treatment of the ZrO₂ nano-particles was carried out using 10 g of 4-vinylbenzoic acid, in place of 25 g of biphenyl-4-carboxylic acid used in Example 2. Except for this, a curable resin-fine particle composite material was produced similarly to as described in Example 2, and then evaluated. Results were shown in Table 1.

### Example 6

In Example 6, the surface treatment of the ZrO₂ nano-particles was carried out using triphenylacetic acid, in place of the biphenyl-4-carboxylic acid used in Example 3. Except for this, a curable resin-fine particle composite material was produced similarly to as described in Example 3, and then evaluated. Results were shown in Table 1.

### Example 7

In Example 7, the surface treatment of the ZrO₂ nano-particles was carried out using 25 g of 4-phenoxybenzoic acid, in place of 25 g of biphenyl-4-carboxylic acid used in Example 2. Except for this, a curable resin-fine particle composite material was produced similarly to as described in Example 2, and then evaluated. Results were shown in Table 1.

TABLE 1

| | | | | Amount of | |
|---|---|---|---|---|---|
| | Surface treatment agent | | | filling | |
| | First surface | Second surface | | of particles | Refractive |
| | treatment agent | treatment agent | Third surface treatment agent | (wt %) | index |
| Example 1 | Stearic acid 10 g | Methacrylic acid | Benzoic acid 50 g | 11 | 1.60 |
| | | 20 mL | | 19 | 1.61 |
| | | | | 32 | 1.62 |
| Example 2 | Stearic acid 10 g | Methacrylic acid | Biphenyl-4-carboxylic | 20 | 1.61 |
| | | 20 mL | acid 25 g | 33 | 1.64 |
| | | | | 38 | 1.65 |
| Example 3 | Dodecanoic | Methacrylic acid | Biphenyl-4-carboxylic | 20 | 1.61 |
| | acid 10 g | 10 mL | acid 10 g | 25 | 1.63 |
| Example 4 | Stearic acid 10 g | Methacrylic acid | 2-Naphthoic acid | 22 | 1.62 |
| | | 10 mL | 25 g | 44 | 1.67 |
| | | | | 54 | 1.68 |
| Example 5 | Stearic acid 10 g | Methacrylic acid | 4-Vinylbenzoic acid | 24 | 1.61 |
| | | 20 mL | 10 g | 33 | 1.62 |
| Example 6 | Dodecanoic | Methacrylic acid | Triphenyl acetate | 19 | 1.60 |
| | acid 10 g | 10 mL | 10 g | 29 | 1.62 |
| Example 7 | Stearic acid 10 g | Methacrylic acid | 4-Phenoxybenzoic acid | 19 | 1.61 |
| | | 20 mL | 25 g | 25 | 1.63 |
| | | | | 45 | 1.66 |

In Table 1, the amount of filling of particles is a value obtained solely based on the mass of the ZrO₂ nano-particles, without including the mass of the coating agents. In the coated ZrO₂ nano-particles (particle size of 8 nm), mass fraction of the ZrO₂ nano-particles was found to fall in the range from approximately 70 to 80%, and residual 20 to 30% was found to account for mass fraction of the surface treatment agents.

Transmissivity of light of the curable resin-fine particle composite materials obtained in Examples 1 to 7 was found to be 90% or larger under a light path of 0.5 mm at 380 to 750 nm. As shown in Table 1, the curable resin-fine particle composite material having a refractive index of larger than 1.58, which is a refractive index of a fluorene group-containing acryl resin material as a curable resin material, was obtained in all Examples. The degree of increase in the refractive index varied depending on the species of the third surface treatment agent. Use of the third surface treatment agent causative of larger degree of increase in the refractive index might be more preferable in view of improving the refractive index, but the superiority should generally be evaluated also from the viewpoints of light resistance and heat resistance.

### Example 8

In Example 8, a curable resin-fine particle composite material was produced similarly to as described in Example 1, except that the third surface treatment agent was not used, and that 10 g of stearic acid as the first surface treatment agent, and 50 mL of methacrylic acid as the second surface treatment agent were used. In the obtained curable resin-fine particle composite material, the ZrO₂ nano-particles were found as being stably dispersed into the resin material. The refractive index was found to be 1.58 or larger, but was lower than that of the curable resin-fine particle composite material produced in Example 1. From this Example, it was found that the third surface treatment agent is effective for improving the refractive index of the curable resin-fine particle composite material.

### Comparative Example 1

In Comparative Example 1, a curable resin-fine particle composite material was produced similarly to as described in Example 1, except that stearic acid, methacrylic acid and benzoic acid were not used. In thus-obtained curable resin-fine particle composite material, the ZrO₂ nano-particles were found to be agglomerated in the resin to a considerable degree.

### Comparative Example 2

In Comparative Example 2, a curable resin-fine particle composite material was produced similarly to as described in Example 1, except that p-cumylphenoxyethyl acrylate was not used. The obtained curable resin-fine particle composite material was found to have a viscosity at 80° C. of larger than 1×10⁵ mPa·s, proving inadequacy in thin film coating, printing, injection and so forth.

### Comparative Example 3

In Comparative Example 3, a curable resin-fine particle composite material was produced similarly to as described in Example 1, except that 9,9′-bis(4-(2-acryloxyethoxy)phenyl)fluorene was not used. The obtained curable resin-fine particle composite material was found to have a refractive index of smaller than 1.58.

### Comparative Example 4

In Comparative Example 4, a curable resin-fine particle composite material was produced similarly to as in Example 8, except that methacrylic acid as the second surface treatment agent was not used, but only 10 g of stearic acid as the first surface treatment agent was used. In the obtained curable resin-fine particle composite material, the ZrO₂ nano-particles were found to be agglomerated in the resin material to a considerable degree. From comparison of this Example with Example 8, it may be understood that the second surface treatment agent plays a substantial role of preventing agglomeration and of improving the dispersibility of the ZrO₂ nano-fine particles in the resin-fine particle composite material.

As disclosed in Japanese Patent Application Nos. 2005-230606, 2006-131672 and 2006-135044, the nano-particles covered with specific surface treatment agents may uniformly be dispersed in specific silicone resins. The nano-particles-silicone resin composite materials produced by these techniques showed transparency, refractive indices equivalent to or larger than those of epoxy resin, excellence in heat resistance and light resistance, and viscosity suitable for forming the sealing member, so that LEDs sealed using these materials were excellent in durability.

On the other hand, fluorene group-containing acryl resins raised in the refractive index by introducing fluorene groups have been attracting public attentions, but no method of uniformly dispersing the nano-particles into fluorene group-containing acryl resins, without causing agglomeration, has been disclosed. In order to use the fluorene group-containing acryl resin-fine particle composite as the sealing member for LED and so forth, the fluorene group-containing acryl resin-fine particle composite material before being cured should have an appropriate viscosity so as to allow disposition thereof by thin film coating, printing, injection and so forth. Moreover, in the LEDs sealed using these materials, the fluorene group-containing acryl resin-nano-particles composite should have an appropriate level of hardness, so far as the composite would not be separated from the chip, would not injure the chip, or would not break the interconnects. No technique of realizing them have been disclosed.

The Examples proved that, according to the curable resin-fine particle composite material and the method of producing the same, the fluorene group-containing acryl resin-fine particle composite material, which is transparent, and improved in the refractive index as compared with the case where only the resin was used, was obtainable by combining the fluorene group-containing acryl resin with appropriate first surface treatment agent to third surface treatment agent, by preliminarily treating the surface of the ZrO₂ nano-particles with these surface treatment agents, and by mixing them with the fluorene group-containing acryl resin material. Moreover, the fluorene group-containing acryl resin-fine particle composite material, having a refractive index of 1.58 or larger, and having a viscosity suitable for forming the sealing member of LED, was obtainable by combining a specific fluorene group-containing acryl resin material and a specific monovalent acryl resin material. Moreover, as has been proven by the LED configured by using, as the sealing member, the fluorene group-containing acryl resin-fine particle composite obtained by curing this material, the fluorene group-containing acryl resin-fine particle composite material was obtained as having an appropriate level of hardness, so far as the composite would not be separated from the chip, would not injure the chip, or would not break the interconnects.

The present application has been described referring to Embodiments and Examples, without limiting the present application, while allowing any modifications without departing form the spirit of the present application.

The curable resin-fine particle composite material and the method of producing the same, the optical material composed of the resin-fine particle composite obtainable by curing the curable resin-fine particle composite material and modified in characteristics through addition of the inorganic fine particles, and the light emitting device using the optical material are applicable to any fields where incidence and emission of light are required, and are contributive to improvement in characteristics of optical devices, in particular light emitting devices.

It should he understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A curable resin material-fine particle composite material comprising:
a resin material of an uncured or semicured resin material; and
fine particles composed of an inorganic material dispersed in the resin material,
wherein the surface of the fine particles is treated by at least a first surface treatment agent and a second surface treatment agent, and
the first surface treatment agent and the second surface treatment, agent are composed of molecules represented by the general formulas (1) and (2), respectively:
first surface treatment agent: R¹—X¹ (1)
second surface treatment agent: R²—X² (2)
wherein R¹ represents a long-chain aliphatic or alicyclic hydrocarbon group for preventing agglomeration of the fine particles, a hydrogen atom of the hydrocarbon group may be substituted by a substituent, R² represents a hydrocarbon group having a structure showing affinity with at least a portion of monomers composing the resin material, and having a reactive portion polymerizable with the resin material in the process of curing thereof, or a derivative group produced by substituting a hydrogen atom with a substituent, and X¹ and X² independently represent a carboxyl group —COOH, hydrohydroxyphosphoryl group —PH(O)(OH), phosphono group —PO(OH)₂, sulfino group —SO(OH), sulfo group —SO₂(OH), thiol group —SH, amino group —NH₂, or vinyl group —CH═CH₂.

2. The curable resin material-fine particle composite material as claimed in claim 1, wherein R¹ represents a substituted or non-substituted hydrocarbon group having 5 to 18 carbon atoms.

3. The curable resin material-fine particle composite material as claimed in claim 1, wherein R² represents a substituted or non-substituted hydrocarbon group having 2 to 4 carbon atoms, and having a carbon-carbon double bond at the terminal thereof.

4. The curable resin material-fine particle composite material as claimed in claim 1, wherein R² has a structure similar to that of at least one of the principal chain and a side-chain of the monomer composing the resin material.

5. The curable resin material-fine particle composite material as claimed in claim 1, wherein the surface of the fine particles is treated with the first surface treatment agent, the second surface treatment agent, and a third surface treatment agent expressed by the general formula (3):
third surface treatment agent: R³—X³ (3)
wherein R³ represents an aromatic hydrocarbon group or aromatic heterocyclic group, a hydrogen atom of the aromatic hydrocarbon group or aromatic heterocyclic group substituted by a substituent, and X³ represents a carboxyl group —COOH, hydrohydroxyphosphoryl group —PH(O)(OH), phosphono group —PO(OH)₂, sulfino group —SO(OH), sulfo group —SO₂(OH), thiol group —SH, amino group —NH₂, or vinyl group —CH═CH₂).

6. The curable resin material-fine particle composite material as claimed in claim 1, wherein the composite material is transparent.

7. The curable resin material-fine particle composite material as claimed in claim 6, wherein the uncured or semicured resin material contains an acryl resin material.

8. The curable resin material-fine particle composite material as claimed in claim 7, wherein the composite material has a refractive index of 1.58 or larger.

9. The curable resin material-fine particle composite material as claimed in claim 7, wherein the composite material has a viscosity of 1×10⁵ mPa·s or smaller at 80° C.

10. The curable resin material-fine particle composite material as claimed in claim 7, wherein a fluorene-group-containing acrylate and/or methacrylate are contained as a monomer composing the acryl resin material.

11. The curable resin material-fine particle composite material as claimed in claim 10, wherein at least one of a fluorene-group-containing acrylate and methacrylate expressed by general formula (4), and at least one of a monofunctional acrylate and methacrylate expressed by general formula (5) and general formula (6), are contained as a monomer composing the acryl resin material:
fluorene-group-containing acrylate or methacrylate: 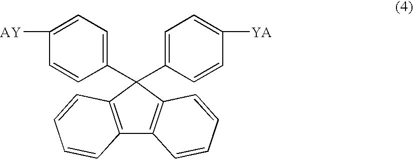
wherein A represents an acryloyloxy group or methacryloyloxy group, and Y represents a —(CH₂CH₂O)ₙ— or (CH₂CH₂O)ₙ—CH₂CH(OH)CH₂O—, n=1 to 5; and
monofunctional acrylate or methacrylate:
B-Z-T (5)
and
B-Z-T(R^{X})ₘ (6)
wherein B represents an acryloyloxy group or methacryloyloxy group, Z represents —(CH₂CH₂O)ₙ— or —(CH₂CH₂CH₂O)ₙ—, n=1 to 5, or, —(CH₂CH₂O)ₙ₁—(CH₂CH₂CH₂O)ₙ₂—, n1+n2=2 to 5, T represents an aromatic hydrocarbon group, a part of hydrogen atom(s)of the aromatic hydrogen group may be substituted by substituent(s) as expressed by the general formula (6), R^{X} represents a methyl group, bromine atom or iodine atom, and m=1 to 6.

12. The curable resin material-fine particle composite material as claimed in claim 11, wherein the composite material has a ratio by mass of blending of the monofunctional acrylate and methacrylate to the fluorene-group-containing acrylate and methacrylate of 0.2 to 2.

13. The curable resin material-fine particle composite material as claimed in claim 1, wherein the inorganic material has a refractive index of 1.9 or larger.

14. The curable resin material-fine particle composite material as claimed in claim 13, wherein the inorganic material is composed of at least one inorganic substance selected from the group consisting of titanium oxide, strontium titanate, zirconium oxide, cerium oxide, hafnium oxide, niobium pentoxide, tantalum pentoxide, indium oxide, tin oxide, indium oxide tin (ITO), zinc oxide, zinc sulfide, and simple substance of silicon.

15. The curable resin material-fine particle composite material as claimed in claim 1, wherein the fine particles have a particle size of 20 nm or smaller.

16. The curable resin material-fine particle composite material as claimed in claim 1, wherein the composite material is used as a filler material for disposing a refractive index adjusting component on a light path of a light emitting device.

17. A method of producing a curable resin material-fine particle composite material having fine particles composed of an inorganic material dispersed in an uncured or semicured resin material, wherein:
the surface of the fine particles is treated by at least a first surface treatment agent and a second surface treatment agent, and
the first surface treatment agent and the second surface treatment agent are composed of molecules expressed by general formulas (1) and (2), respectively, the method comprising:
dispersing, in a solvent containing at least the first surface treatment agent and the second surface treatment agent, the fine particles so as to resolve secondary agglomeration thereof, and so as to be treated on the surface thereof with the first surface treatment agent and the second surface treatment agent; and
then mixing the treated fine particles with the uncured or semicured resin material:
first surface treatment agent: R¹—X¹ (1)
second surface treatment agent: R²—X² (2)
wherein R¹ represents a long-chain aliphatic or alicyclic hydrocarbon group preventing agglomeration of the fine particles, a hydrogen atom of the hydrocarbon group substituted by a substituent, R² represents a hydrocarbon group having a structure showing affinity with at least a portion of monomers composing the resin material, and having a reactive portion polymerizable with the resin material in the process of curing thereof, or a derivative group produced by substituting a hydrogen atom with a substituent, and X¹ and X² independently represent a carboxyl group —COOH, hydrohydroxyphosphoryl group —PH(O)(OH), phosphono group —PO(OH)₂ , sulfino group —SO(OH), sulfo group —SO₂(OH), thiol group —SH, amino group —NH₂, or vinyl group —CH═CH₂.

18. An optical material composed of a resin-fine particle composite obtained by curing the curable resin material-fine particle composite material according to any one of claims 1.

19. The optical material as claimed in claim 18, wherein the optical material is used as a filler for light emitting device.

20. A light emitting device configured so that light emitted from a light emitting element is extracted through the optical material according to claim 18 to the outside.

21. The light emitting device as claimed in claim 20 comprising the light emitting element and a sealing member sealing the light emitting element, wherein the sealing member is composed of the optical material.

22. The light emitting device as claimed in claim 21, wherein the light emitting element is disposed in a recess of a reflective cup, the sealing member is disposed to fill the recess in contact with the light emitting element, and the device is configured so that light emitted from the light emitting element is extracted through the optical material composing the sealing member to the outside, directly therethrough, or after being reflected on a wall surface of reflective cup.

23. The light emitting device as claimed in claim 20 comprising the light emitting element, a sealing member sealing the light emitting element, and a filler filling the gap between the light emitting element and the sealing member, wherein the filler is composed of the optical material.

24. The light emitting device as claimed in claim 23, wherein the light emitting element is disposed in a recess of a reflective cup, the filler is disposed to fill the recess in contact with the light emitting element, and the sealing member is disposed to be contact with the filler, and the device is configured so that light emitted from the light emitting element is extracted through the optical material composing the filler to the outside, directly therethrough, or after being reflected on a wall surface of reflective cup.

25. The light emitting device as claimed in claim 23, wherein: the sealing member has an axi-symmetrical geometry having a circular bottom surface, a convex-lens-form side face and a concave-lens-form top surface, the bottom surface being provided with a recess, the light emitting element being disposed in the recess at the center position of the bottom surface, the device being configured so that light emitted from the light emitting element is extracted through the side face to the outside, mainly directly therethrough, or after being reflected on the top surface.

26. The light emitting device as claimed in claim 20, comprising one or more of the light emitting elements disposed on a wiring board, and a sealing member sealing the light emitting element provided on the wiring board, wherein the sealing member is composed of the optical material.

27. The light emitting device as claimed in claim 26, wherein light emitting diodes are disposed as the light emitting element in array pattern or matrix pattern to form a backlight unit.
